(19) United States
(12) Patent Application Publication
(10) Pub. No.: US 2011/0016483 A1
(43) Pub. Date: Jan. 20, 2011

(54) SYSTEM AND METHOD FOR DELIVERING AND OPTIMIZING MEDIA PROGRAMMING IN PUBLIC SPACES

(75) Inventor: Thomas C. Opdycke, Bellevue, WA (US)

Correspondence Address: AKA CHAN LLP, 900 LAFAYETTE STREET, SUITE 710, SANTA CLARA, CA, 95050, US

(73) Assignee: DS-IQ, INC., Bellevue, WA (US)

(21) Appl. No.: 12/888,834

(22) Filed: Sep. 23, 2010

Related U.S. Application Data
(62) Division of application No. 10/913,130, filed on Aug. 6, 2004.
(60) Provisional application No. 60/493,263, filed on Aug. 6, 2003.

(51) Int. Cl. H04H 60/32

(52) U.S. Cl. 725/14

(57) ABSTRACT

A system and corresponding methods for automating the execution, measurement, and optimization of in-store promotional digital media campaigns are provided. In one embodiment, a method in a computing system for deploying content to digital signage networks includes receiving from a user a marketing campaign goal and at least one optimization constraint suitable for generating a playlist. The method also includes generating a playlist designed to maximize a learning opportunity to achieve the marketing campaign goal. The method further includes provisioning the playlist to a point of presence on the digital signage network.

### CROSS-REFERENCE TO RELATED APPLICATIONS

This application is a divisional of U.S. patent application Ser. No. 10/913,130, filed on Aug. 6, 2004, which claims the benefit of priority under 35 U.S.C. §119(e) of U.S. Provisional Application No. 60/493,263, filed on Aug. 6, 2003, the entireties of which are incorporated herein by reference.

### BACKGROUND OF THE INVENTION

The described technology is generally directed to advertising and, more particularly, delivering media programming in public spaces.

Companies spend significant resources each year on traditional broad-reach methods of advertising such as television, radio, print, and billboards to distribute their messages in and outside of consumer homes. These advertising campaigns have many drawbacks, including the following: production is costly; placement requires lead times of weeks, months, or quarters; distribution often takes time, is complicated and expensive; changes are time consuming and costly to make as they normally require repeating the production and distribution processes and logistics; uncertain execution—it is difficult for marketers to know whether these traditional forms of advertising actually were implemented in the field, and they try to confirm performance via affidavits or post-process field audits; and untargeted—these methods typically broadcast or display messages to audiences en masse, with little, if any, customization of content specifically for a particular set of viewers.

To address consumers in their homes, advertisers have turned to web-based internet advertising as one method of delivering more targeted content. The use of cookies, account information, machine identifiers, IP addresses, and the like, enables marketers to track consumer behavior and therefore more precisely target messaging. However, targeting, measuring the effectiveness, and optimizing content (such as advertising) displayed outside of the home has presented more of a challenge due to the lack of a consistent association of a customer with a computer, and a corresponding facility to easily measure response.

Outside the home, digital signage networks with numerous geographically disbursed digital displays, sometimes referred to as “narrow casting” systems, make the distribution and dissemination of dynamic content possible. Content can be programmed to change as a function of day-part, day, desired current promotion, and anticipated viewing demographic by locale. These systems typically consist of a server which can be centrally programmed to control any of the displays to dynamically update the programming content.

Despite the above technical ability to precisely deliver content to a given place at a specified time, most implementations remain relatively untargeted with respect to messaging and audiences. One of the reasons for this, and a current drawback of these systems, is that the programming of digital signage today is largely a manual process. The user must explicitly program the signage network with the variations in content and scheduling that would result in a more targeted set of messages and delivery schedule. In other words, it takes a human to decide and know what message to deliver to a given location at a given time. This manual programming is complex and laborious in practice, and could involve a myriad of permutations of content, network, locale, and temporal variations. Thus, users program digital signage networks more like broadcast, where content treatments and schedules are applied to the overall system in very broad strokes. Therefore, it is currently impractical to use these systems to go from broadcast to 1: “a store audience” or 1:1 precision messaging of the kind that is commonly delivered to people on their PCs in their homes. Without a way to intelligently automate this programming, the potential for digital signage to become a truly targeted media is severely limited, if not lost entirely.

Another drawback with conventional digital signage networks is that they lack a direct, automated way to measure the relationship between viewer behavior and the content that is shown on digital signage networks. There have been private studies that attempt to quantify the overall effect of digital signage on sales in retail stores. However, digital signage and behavioral data (such as point of sale) come from completely disparate systems, and the processes in conducting these studies are manual-labor intensive, require specialized knowledge, and are therefore expensive and cost prohibitive to conduct and maintain in perpetuity. Thus the ongoing efficacy of specific implementations of dynamic digital signage and messaging remains unknown. Furthermore, without a system that can measure quantitative results, users are unable to learn how to improve their overall implementations over time, unable to discern which specific content works best in given circumstances and therefore learn how to better target messages. Without a facility for measuring and learning, marketing on digital signage is just guesswork, rather than fulfilling the potential for targeted messaging to the right audience at the right time.

In sum, there are no automated tools that would allow marketers an ability to systematically and quantitatively test content, media scheduling parameters, measure audience behavior, and optimize messaging efficacy with respect to digital signage networks. In other words, even if a marketer has perfect demographic information about the audience, there is no built-in way to discern what combination of visuals, audio, copy, timing, locale, or other elements that make up the programming, will result in the best outcome in terms of the desired results with the audience.

Accordingly, a system for delivering and optimizing media programming in public spaces that overcomes some or all of the above-discussed disadvantages of conventional digital signage networks would have significant utility.

### BRIEF DESCRIPTION OF THE DRAWINGS

FIG. 1 is a block diagram illustrating an environment in which a facility may operate.

FIG. 2 is a block diagram illustrating selected components of a program server computer, according to one embodiment.

FIG. 3 illustrates a flow chart of an integrated behavioral analytics process, according to one embodiment.

FIG. 4 illustrates a flow chart of a method for receiving a marketing object and generating a playlist, according to one embodiment.

FIG. 5 illustrates a flow chart of a feedback loop process, according to one embodiment.

FIG. 6 illustrates a flow chart of a method for previewing playlists, according to one embodiment.

FIG. 7 illustrates a flow chart of a method for creating programming heuristics, according to one embodiment.

FIG. 8 illustrates a flow chart of a method for performing statistical data analysis to measure behavioral response and to dynamically optimize playlists, according to one embodiment.

FIG. 9 illustrates a flow chart of a method for incorporating data from a smart media box in creating playlists, according to one embodiment.

FIG. 10 is a block diagram illustrating a federated network, according to one embodiment.

FIG. 11 is a block diagram illustrating a peer-to-peer network, according to one embodiment.

FIG. 12 is a block diagram illustrating a network interactive with customers through wireless access points, according to one embodiment.

### DETAILED DESCRIPTION OF THE INVENTION

An analytically-driven technology system and corresponding methods for automating the execution, measurement, and optimization of in-store promotional digital media campaigns are provided. In various embodiments of the invention, the analytically-driven technology system and corresponding methods incorporate user or marketer data, customer or viewer behavioral response data, and digital signage or content data to optimize a media campaign to achieve the goals of the user of the system.

In one embodiment, a software facility (“facility”) provides an integrated behavioral analytics for digital signage, which provides users, such as marketers, content creators, signage network operators, etc., the ability to gauge the response, e.g., sales increases, to their digital signage. For example, the facility retrieves viewer behavioral data (e.g., sales data, store foot traffic data, etc.) and data regarding the content actually played on the digital signage (e.g., play logs), and compares the play log data with sales data corresponding to the products promoted by the content displayed or delivered through the digital signage, and provides users a way to view and analyze the comparative results.

In another embodiment, the facility provides a web-based work-flow system that allows users to deploy content to digital signage networks, e.g., content distribution and display systems. Users utilize the facility to specify a goal and one or more constraints (e.g., parameters such as advertising content, time, locale, etc.) of an advertising campaign to measure the effectiveness of a campaign conducted on digital signage network. The facility directly or indirectly collects data from the deployed digital signage network and from systems that measure audience behavior, and then analyzes the collected data to measure correlation and to generate intelligent heuristics or parameters for optimizing how the campaign is executed on the digital signage network.

The facility enables a user to define and manage marketing objects in order to target content displayed via digital signage networks. A marketing object contains or holds the information necessary to create, tailor, run and optimize content on digital signage networks. The marketing object contains the inputs necessary for the facility to generate, distribute, and test the efficacy of playlists so that appropriate digital content for a given digital display and/or audio device is displayed or played at the right time and place. The marketing object gives the user the option to manage a more simple set of parameters that guide the ongoing creation of playlists. From this, an optimized network programming model can be evolved.

A playlist is a list of content entries and specifications that govern how the digital signage network will feature content. A playlist may include the following parameters, such as, by way of example, a list of play-ready clips, content parts, timing parameters such as start date and time of repeat characteristics, locale specifications such as network, nodes, channels, geographic regions, demographic associations, and conditional rules, such as, by way of example, if shopper is purchasing product X then display a picture of product Y, etc. As used herein, the term “digital display” is meant to incorporate the various types of output devices, such as screens, signs, displays, lights, speakers, etc., which may be coupled to and a part of the digital signage networks. During its life-cycle, a marketing object continually refines its model and playlists to improve the learning opportunity and to deliver better results on the digital displays it governs as measured by a specified goal.

The facility enables a user to define a marketing object by specifying a goal, and at least one optimization constraint. The goal is the measure that the user wants to optimize. Examples of a goal include: revenue for a brand, unit volume for product A, number of people that enter the store, etc. A goal can be thought of as the “Y” or dependent variable in a regression equation with the “X” or independent variables being the factors that influence sales of the product(s) in question. The goal is the target variable the facility will derive the optimization function for, and measure its results against.

A marketing object has a set of input variables that specify how the digital signage network plays its content, such as, by way of example: what content to play (such as play ready media clips, content parts, or the metadata that describes a set of media clips to be played), temporal (such as date, daypart, time, and repeat play characteristics), locale (such as store site, channel, retailer, network parameters), demographics (such as income and education levels, or observed behavioral profile clusters mapping to particular geographies such as census blocks or groups of census blocks), and conditional rules. The input variables can be thought of as the “X” or independent variables in the aforementioned regression equation. Users may specify optimization constraints for a marketing object, which are limitations on the marketing object input variables. The facility uses optimization constraints to restrict playlist parameters and to limit the potential universe of solutions for the marketing object optimization function. Types of constraints include, but are not limited to, content (such as play ready media clips, or the metadata that describes a set of media clips to be played), temporal (such as date, daypart, time, and repeat play characteristics), locale (such as store site, channel, retailer, network parameters), and demographics (such as income and education levels, or observed behavioral profile clusters mapping to particular geographies such as census blocks or groups of census blocks).

From the input marketing object, the facility creates a set of playlists that attempt to maximize its learning opportunity to achieve the goal specified in the input marketing object. In one embodiment, the facility may initially define the optimization problem space as the intersection of the constraints and the input variables. Within the defined problem space, the facility can generate the total set of playlists based on the combinatorial permutations of the input parameters, and then select a representative sample across this set of playlists to begin systematic experimentation and running of playlists.

The facility may then upload play logs (e.g., history of the actual media presented) from the digital signage networks, and upload behavioral response data (e.g., viewer or audience response data) from devices such as point-of-sale devices, kiosks, motion tracking devices, etc. These two disparate data sets may then be analyzed to determine the statistical significance and relevance of the marketing object input variables with respect to a specified goal. In one embodiment, conventional multivariate regression is used for this analysis. Other suitable analytical techniques include various forms of conventional regression models, decision trees, k-nearest neighbor, neural networks, rule induction, k-means clustering, and the like.

The facility may then adapt by systematically varying the playlists, or the input variables, based on learning gleaned from analysis of the data and by dynamic optimization principles. Suitable dynamic optimization techniques are described in Dynamic Stochastic Optimization, volume 532 in the series of Lecture Notes in Economics and Mathematical Systems, published by Springer-Verlag in association with IIASA, the entirety of which is incorporated herein by reference. For example, it can seek to vary and test the playlist parameters in order to optimize behavioral response as defined by a goal. The facility may use one or more dynamic stochastic optimization algorithms to accomplish this automatically vs. having a user attempt to manually vary, test, measure, and modify playlist parameters. Other optimization techniques include variants of genetic algorithms, and iterative modification of multivariate regression predictive models. By repeating the experiment design, play, upload data, analysis, modification and optimization process, the facility evolves and learns over time, so that it improves on the set of playlists it sends to the digital signage networks in order to better influence viewer response.

In one embodiment, the facility utilizes aggregated knowledge and data mining technology (such as variations of the aforementioned statistical techniques) to discover behavior patterns that would suggest a set of initial playlist heuristics the facility should use towards optimizing the goal. In situations where the user believes a marketing campaign has similar characteristics to a prior campaign, this function provides a way to leverage prior learning and data so that the facility might generate a better performing set of playlists set more quickly vs. starting the process with no historical data or experience.

In still another embodiment, a user may optionally specify content parts and a template from which the facility generates play ready clips to be displayed on the digital displays. A play-ready clip is the content suitable for playback on a digital signage network. Content parts are the elements that may be combined to generate the digital content or play ready clip, such as, by way of example, images, text, and sounds. A template defines how content parts should be assembled to form a holistic visual. The facility may automatically create multiple play ready clips by assembling combinations of the content parts according to the specified template.

In yet another embodiment, a user may also optionally specify conditional rules which work in conjunction with the playlist that is created by the facility. A conditional rule may impose a certain condition on the programming of the content that is delivered by the digital signage networks and are useful when linked to events that are typically exogenous to the digital signage network. For example, conditional rules may dictate which digital display participates in the campaign, may specify conditional or collaborative filtering of the digital content that is delivered, may dictate which playlist is invoked or a choice of a playlist from multiple playlists based on variables such as, by way of example, current shopping cart contents, personal or audience identification, inventory levels, weather conditions, etc.

In a further embodiment, the facility receives information regarding the digital displays in the digital signage networks and uses this information to define and/or determine the playlists and the programming schedule. For example, a media box coupled to a digital display may broadcast environment characteristics and technical capabilities of a coupled digital display, provide information about the audience, and provide the audience a means to interact with the display. The facility may utilize this information in a variety of ways such as, by way of example, to automatically determine or guide playlist parameters in the optimization or to invoke digital signage activity based conditional rules.

Another embodiment of the invention involves federating, or linking, disparate signage networks to a central system in order to aggregate and identify demographic, response, signage device characteristics and data across the sum of the networked devices. This enables centralized content programming, monitoring, cost settlement, and management of the collective networked devices (screen real estate, response data, and other network resources) on behalf of the individual participating network federation members. With this embodiment a firm can market these resources to third parties or other federation members who may wish to rent the use of particular network resources—such as advertising inventory to individuals, a particular demographic, in a particular venue or class of venues, at particular times.

Previous digital signage systems are configured at a location by using a single content server for a plurality of displays. An embodiment of the invention configures media boxes and display devices in a peer-to-peer network environment. In this embodiment the media boxes share computing and storage resources with other peers on the network. Rule sets, content parts, and other data can be distributed across media boxes on the network. Thus, individual nodes of the signage network are not dependent upon a local master content and/or rules server, and network capacity is incrementally scalable. If an individual media box or parts of it fail, the display and/or media box can fetch what it needs from other peers on the network or from a centralized management/directory server accessed over the internet.

Another embodiment of the invention turns digital signage from one-way display devices into public, two-way interactive devices. The signs, equipped with a media box or other computer, enable audiences to interact with public displays, access more information, and/or purchase products remotely, using devices such as personal digital assistants, phones, notebook and palm-sized computers. The signage may be programmed to change as a person browses the network, or in an alternative embodiment, the public display does not change and the individual gains access to additional content displayed on his or her personal device. The result is that the audience has quick, direct access to more information and/or to a mechanism to purchase products via the interactive signage device.

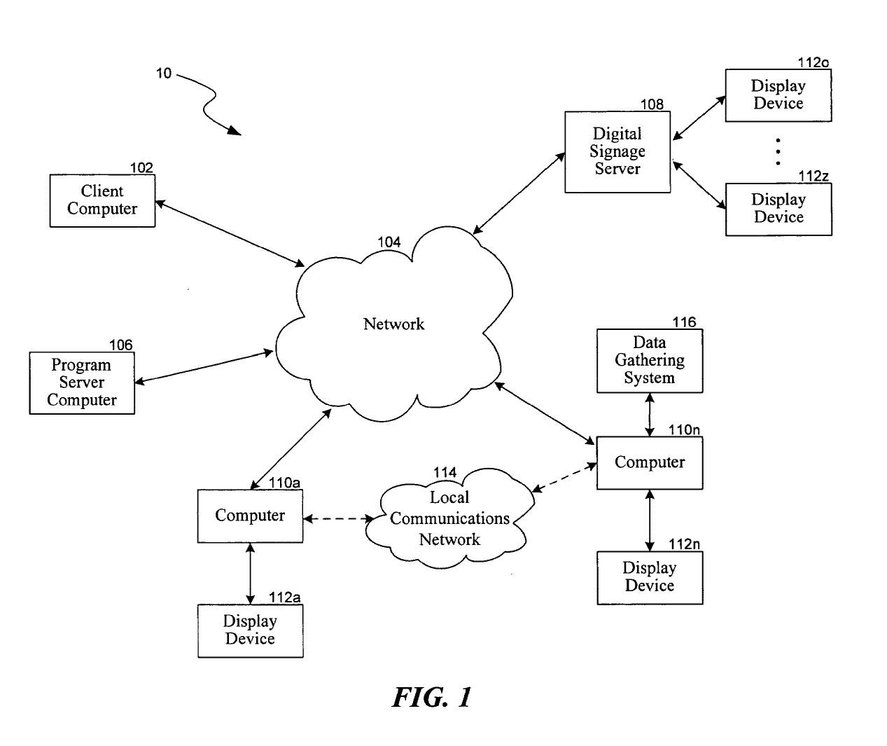

The various embodiments of the facility and its advantages are best understood by referring to FIGS. 1-12 of the drawings. The elements of the drawings are not necessarily to scale, emphasis instead being placed upon clearly illustrating the principles of the invention. Throughout the drawings, like numerals are used for like and corresponding parts of the various drawings.

FIG. 1 is a block diagram illustrating an environment 10 in which the facility may operate. As depicted, environment 10 includes a client computer 102, a program server computer 106, a digital signage server 108, and computers, e.g., computers 110a-110m, coupled to a network 104.

Client computer 102 may be any type of computer system that provides its user the ability to load and execute software programs and the ability to access a network, such as, for example, network 104, and communicate with, for example, program server computer 106. In one embodiment, client computer 102 is a personal computer executing a suitable operating system program that supports the loading and executing of application programs, such as a web browser or other suitable user interface program, for interacting with and accessing the services provided on program server computer 106.

Network 104 is a communications link that facilitates the transfer of electronic content between, for example, the attached computers. In one embodiment, network 104 includes the Internet. It will be appreciated that network 104 may be comprised of one or more other types of networks, such as a local area network, a wide area network, a point-to-point dial-up connection, and the like.

In general terms, program server computer 106 serves as a platform for analytically-driven, suggestive behavior-modifying solutions in programming environments. Program server computer 106 provides services to enable creation of real-time or near real-time, intelligent, positive feedback loops by dynamically linking the delivery of controlled sensory input, e.g., digital sign images, pricing, type and volume of music, heat level, light level, etc., to a targeted population and/or population segment, the ongoing collection and analysis of target population behavioral data, e.g., response data, population traffic data, etc., and provides the iterative input variable modification based, for example, on the analytics and optimization techniques previously discussed, in order to more effectively influence audience behavior towards a desired goal or result.

In general terms, digital signage server 108 and computers 110a-110n represent the content delivery software and media player/appliances that compose a digital signage network(s). As depicted in FIG. 1, digital signage server 108 is shown coupled to a plurality of display devices, e.g., display devices 112o-112z, and computers 110a-110n are each coupled to a display device, e.g., display devices 112a-112n, respectively. Digital signage server 108 and each of computers 110a-110n provide management of the coupled display devices. For example, digital signage server 108 may store the playlists and control the presentation of the content on the coupled display devices based on the playlists. Moreover, digital signage server 108 may also store data, such as, by way of example, viewer behavioral data, play logs, and the like, and provide this data to program server computer 106.

As indicated by the dashed or dotted lines in FIG. 1, computers 110a-110n may also be coupled to a local communications network 114, Similar to network 104, local communications network 114 is a communications link that facilitates the transfer of electronic content between the attached computers. In one embodiment, local communications network 114 may be an intranet belonging to an organization, such as a department store, and serves to facilitate communication between and amongst the computing, communication, and display devices belonging to the organization.

For example, there may be hundreds or thousands of web pages, images, sounds, and other variations of programming content, or any other piece of data that could potentially be presented at a given display device. It would take a large amount of memory and bandwidth to distribute and store the totality of content at each computer. Local communications network 114 enables a coupled computer, for example, computer 110a, to check its local store to see if a particular item of content in demand is available in the local store. If it is not available, the computer can query its peers, e.g., the other computers coupled to local communications network 114, for the content and retrieve the content from a more efficient source without having to utilize network 104.

A data gathering system 116 is shown coupled to computer 110n in FIG. 1. In general terms, data gathering system 116 may facilitate transactions and/or may identify the audience located in front of or proximate the display device, e.g., display device 112n, coupled to computer 110n. Examples of data gathering system 116 include loyalty, credit, and debit card readers, biometric devices, such as fingerprint, retinal, and voice recognition scanners, cameras, motion, temperature, and pressure sensors, touch screen monitors, kiosks, and the like. Data gathering system 116 provides for audience identification and the gathering of audience behavioral data, which, in turn, can invoke a targeted playlist experience. For example, the audience behavioral data is provided to program server computer 106, which uses the data to produce and provision the appropriate playlist to computer 110n.

The computer systems of client computer 102, program server computer 106, digital signage server 108 and computers 110a-110n may include a central processing unit, memory, input devices (e.g., keyboard and pointing devices, sensory devices, personal identification devices, etc.), output devices (e.g., displays, directional speakers, etc.), and storage devices (e.g., disk drives, etc.). The memory and storage devices are computer-readable media that may contain instructions that implement the facility.

Environment 10 is only one example of a suitable operating environment and is not intended to suggest any limitation as to the scope of use or functionality of the facility. Other well-known computing systems, environments, and configurations that may be suitable for use include client computers, server computers, hand-held or laptop devices, multiprocessor systems, microprocessor-based systems, programmable consumer electronics, network PCs, minicomputers, mainframe computers, distributed computing environments including any of the above systems or devices, and the like.

The facility may be described in the general context of computer-readable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

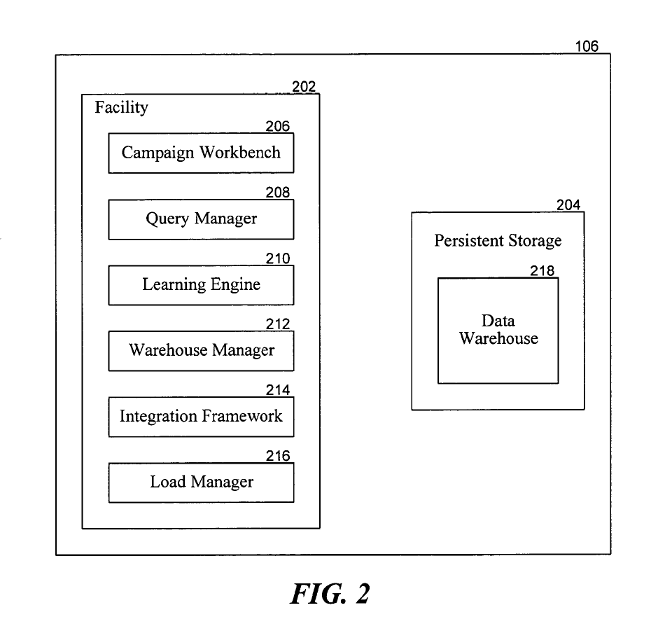

FIG. 2 is a block diagram illustrating selected components of program server computer 106, according to one embodiment. As depicted, program server computer 106 comprises a facility 202 and a persistent storage 204. It will be appreciated that program server computer 106 includes other components that are typically found on a computer suitable for hosting facility 202 as described herein. For example, program server computer 106 also includes a processing unit, memory, network interface, input/output interfaces and devices, and the like.

Facility 202 generally functions to provide an architecture for creation, testing, measuring, learning and optimizing media playlists in conjunction with digital signage networks. In particular, facility 202 contains the logic for enabling automated creation, execution, measurement, learning and optimization of media campaigns by systematically providing messaging that incorporates user data, viewer behavioral response data, and content data, as described herein. As depicted in FIG. 2, facility 202 comprises a campaign workbench 206, a query manager 208, a learning engine 210, a warehouse manager 212, an integration framework 214 and a load manager 218.

Campaign workbench 206 generally functions as an interface into the services provided on program server computer 106. In one embodiment, campaign workbench 206 is a web-based workflow system that allows users to create campaigns, deploy content to digital signage networks, and to measure and view results with respect to audience behavior metrics. Campaign workbench 206 may include one or more pages (e.g., user interfaces) that provides its user the ability to define marketing objects (e.g., input variables, goals and constraints). Campaign workbench 206 may also include pages that provide its user the ability to create and/or specify variables that instruct facility 202 how to measure and analyze results of a campaign, and how the optimization should function.

Query manager 208 generally functions as an interface for the other components of facility 202 to get access to the data in the various data stores on and/or maintained by program server computer 106. In one embodiment, query manager 208 contains logic to perform the operations associated with the management of user queries, e.g., the queries submitted via campaign workbench 206.

Learning engine 210 generally functions to analyze the data, measure behavioral results with respect to media programming, and to generate rules for optimizing playlists prepared for a campaign or marketing object based on analysis of audience behavior. In one embodiment, learning engine 210 implements statistical analysis in conjunction with aggregated knowledge and data mining technology, machine learning and optimization algorithms, such as, by way of example, various forms regression models, decision trees, k-nearest-neighbor, neural networks, rule induction, k-means clustering, and the like. Learning engine 210 may then adapt by systematically varying the playlists, or their parameters, based on learning gleaned from the analysis of the data. Learning engine 210 may then operate based on the principles of stochastic dynamic optimization. It can seek to vary and test the playlist heuristics in order to optimize behavioral response as defined by a goal. Learning engine 202 may use one or more stochastic optimization algorithms to accomplish this automatically as referenced above. By repeating the experiment design, play, upload data, analyze, modify and optimize process, facility 202 evolves and learns over time, so that it improves on the set of playlists it sends to the digital signage networks in order to better influence viewer response.

Warehouse manager 212 contains logic to perform the operations associated with the management of the data in a data warehouse 218. Warehouse manager 212 may perform operations such as, by way of example, analyzing data to ensure consistency with a database schema, e.g., a schema employed by data warehouse 218, transferring and merging the source data from a temporary staging storage into a table in data warehouse 218, generating aggregations of data in data warehouse 218, backup and archiving of data, etc. Data warehouse 218 is further described below.

Integration framework 214 generally functions as an interface that provides integration between facility 202 and the digital signage networks. In one embodiment, integration framework 214 is implemented as a web service interface that allows content to be exchanged between facility 202 and the digital signage networks. For example, integration framework 214 provides content delivery software for an application executing on a digital signage network the ability to retrieve the playlists from facility 202, enables facility 202 to provision playlists to the components of a digital signage network, and enables the uploading of play logs by facility 202 from the digital signage network.

Load manager 216 contains the interface and logic to perform the operations associated with the integration with behavioral data gathering and storage systems, and/or the extraction and loading of data into data warehouse 218. This set of processes may be automated. In one embodiment, load manager 216 is implemented as a collection of data gathering and loading tools for behavioral data capture systems, e.g., point of sale systems, monitoring systems, etc., and custom-built programs for interacting with these systems. For example, load manager 216 uploads and processes the data, e.g., viewer behavioral data, from the vendor systems to remove the irrelevant operational data and to ensure data integrity for the services provided by facility 202.

Persistent storage 204 is a computer-readable storage medium that persistently stores the computer programs and data, including data structures, on community services server computer 106. As depicted, persistent storage 202 comprises data warehouse 218. Data warehouse 218 generally provides a database environment capable of digesting large amounts of measured audience behavioral data such as point of sale logs, and digital signage data such as play logs, for analysis. For example, data warehouse 218 serves as a repository for the data collected, processed, and generated by facility 202 in providing the services described herein. Additional examples of such data include digital signage network integration templates, playlist schemas that describe playlist parameters across various digital signage networks, product dictionaries that describe the hierarchy of products (such as category, brand, line, and stock keeping unit) for companies, digital signage metadata, operational data, workflow definition schema, workflow definition templates, consumer behavioral response data, marketing object, playlist and content efficacy analysis, marketing data, external data mapping templates, and the like.

In one embodiment, data warehouse 218 is implemented based on Microsoft SQL Server 2000® and its business intelligence platform. SQL Server features provide relational and multidimensional data warehousing, OLAP, data mining, and build and manage capabilities for relational and multidimensional data warehouses.

The aforementioned components of program server computer 106 are only illustrative, and program server computer 106 may include other components and modules not depicted. The depicted components and modules may communicate with each other and other components comprising, for example, community service server computer 106 through mechanisms such as, by way of example, interprocess communication, procedure and function calls, application program interfaces, other various program interfaces, and various network protocols. Additionally, the functionality provided for in the components and modules may be combined into fewer components and modules or further separated into additional components and modules.

In the discussion that follows, embodiments of program server computer 106 and facility 202 are described in conjunction with a variety of illustrative examples. It will be appreciated that the embodiments of program server computer 106 and facility 202 may be used in circumstances that diverge significantly from these examples in various respects.

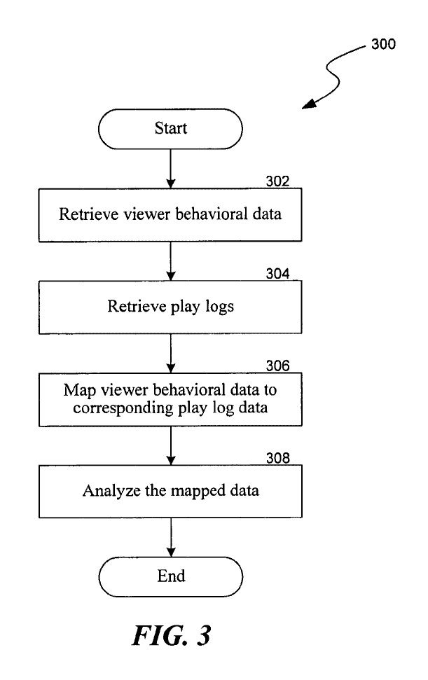

FIG. 3 illustrates a flow chart of an integrated behavioral analytics process 300, according to one embodiment. By way of example, a digital signage network may be executing a playlist, or multiple playlists, composed of ContentA, ContentB and ContentC that advertises Product1. Product1 may actually be a single product or a plurality of products such as would comprise a product line, brand or category. A point-of-sale device may be collecting and registering data regarding sales of Product1, by way of example, this would comprise the viewer behavioral data.

At step 302, facility 202 retrieves viewer behavioral data from the point-of-sale device. Continuing the above example, the viewer behavioral data may be a record of the sales (e.g., units or revenue) of Product1 and an indication of the time and location each of the items were sold. At step 304, facility 202 retrieves the play logs, which contain information regarding the actual content presented on the digital signage across the digital signage network. In the above example, the play logs may specify the proximate date, time, and location each of ContentA, ContentB, and ContentC was played.

At step 306, facility 202 maps the viewer behavioral data to the corresponding play log data. In the above example, facility 202 may determine the sales of Product1 while ContentA, ContentB, and ContentC were being played or soon after. Furthermore, in the above example, facility 202 may determine the sales, or ratio of sales, of Product1 while ContentA was being played or soon after, while ContentB was being played or soon after, and while ContentC was being played or soon after. Stated differently, facility 202 automates the process of correlating viewer behavioral data to the appropriate play log data.

At step 308, facility 202 analyzes the mapped data. In the above example, the data may be analyzed based on the units or revenue of Product1 sold during the proximate times and locations the particular content advertising the particular product was being played. The analysis may be presented to a user in various graphical and textual forms. Subsequent to analyzing the data using one of the aforementioned techniques such as multivariate regression, facility 202 proceeds to an end step.

Those of ordinary skill in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps without detracting from the essence of the invention.

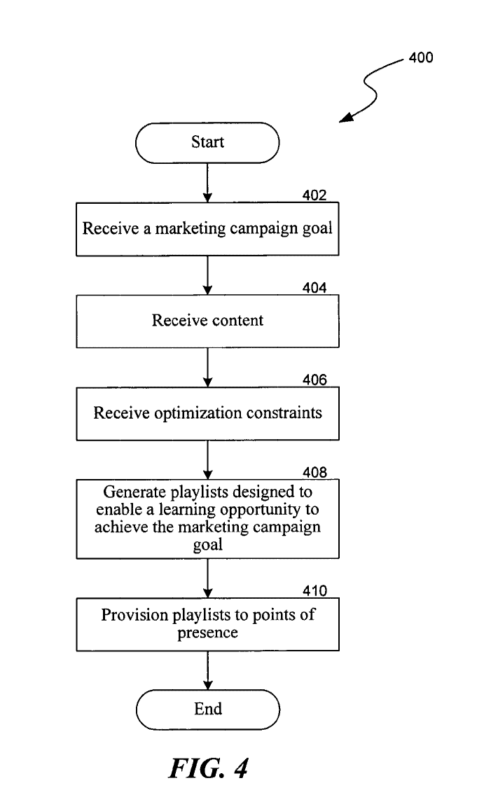

FIG. 4 illustrates a flow chart of a method 400 for receiving a marketing object and generating a playlist, according to one embodiment. By way of example, a user may decide to run a campaign designed to maximize the revenue generated from the sale of “DrinkX ” Here, the user can execute a browser application on client computer 102 and connect to program server computer 106 in order to access facility 202. The user can then define a marketing object for the marketing campaign.

At step 402, facility 202 receives as input from the user a marketing campaign goal. Generally, a goal defines the question the user would like to answer. In one embodiment, a goal comprises a scope and a metric. The scope may be thought of as a product or service hierarchy of category, brand, line, or stock keeping unit (SKU), and the like. The scope may be particular to a given product or service. The metric is what the user wants to measure, such as, by way of example, revenue, volume, units, and the like. Continuing the DrinkX example, the scope may be brand, which would comprise all stock keeping units (such as all flavors and sizes) with the brand “DrinkX ” The metric may be “revenue.” Thus, the goal may be to “maximize the revenue from the sale of all products branded DrinkX.”

At step 404, facility 202 receives as input from the user content, or a pointer to content (such as a uniform resource locator), that is to be delivered through the digital signage network as directed by the marketing object. In one embodiment, the user specifies one or more content treatments, or play ready clips, where a play ready clip is content that is ready to be played on the digital signage. Continuing the DrinkX example, play ready clip A may be a still photo of a model drinking DrinkX that includes a tag line “DrinkX energizes the soul” at the bottom of the photo. Play ready clip B may be an mpeg video showing the model drinking DrinkX with the sound of the model saying “DrinkX energizes the soul.”

In another embodiment, facility 202 receives as input from the user content parts and a template specification. The content parts are the elements that may be used in creating a play clip or content, which is to be delivered through the digital signage network. A template specification defines how the content parts are to be assembled to create a holistic visual (e.g., the play clip or content). Templates allow for consistent placement of content parts and content rendering and templates create a set of heuristics for facility 202 to handle displays of varying technical specification. Examples of template specifications include “place text in the upper right hand corner,” “if screen is in portrait format, use template A, if screen is in landscape format use template B,” “if screen size is greater than 10, display text in 24-point font, else, display text in 14-point font,” “if displaying a video with audio, do not display text,” and the like.

Continuing the DrinkX example, content parts for clip A might include: a still photo of a model drinking DrinkX in a portrait format, a still photo of a model drinking DrinkX in landscape format, a still photo of a group of people drinking DrinkX in portrait format, a still photo of a group of people drinking DrinkX in landscape format, text with the tag line “DrinkX energizes the soul,” and text with a second tag line “DrinkX is for you.” Similarly, content parts for clip B may include: a short mpeg video of a model drinking DrinkX, another mpeg video of a model pouring DrinkX into a glass, an audio track with the voice-over saying “DrinkX energizes the soul,” and another audio track with the voice-over saying “DrinkX is for you.” An example template specification for clip A may be “In landscape mode overlay the image with the tag line right-justified in the lower right section of the screen. In portrait mode overlay the image with the tag line centered across the bottom of the screen.” Facility 202 uses the template specifications as instructions for creating and applying rules for rendering multiple variations of play ready clips based on assembling the different combinations of content parts. In the DrinkX, clip A example above, facility 202 generates eight (8) play ready clips (e.g., the combination of two photos, two formats, and two tag lines, or 2×2×2=8 variations). Similarly, facility 202 would generate 4 variations for clip B (e.g., 2 video×2 audio=4 variations).

At step 406, facility 202 receives input variables and optimization constraints from the user. The input variables and optimization constraints are the parameters that facility 202 uses to generate playlist and playlist optimization parameters in order to improve digital signage programming towards the specified goal. The constraints may also serve to limit the possible optimization universe of solutions. In one embodiment, the constraints can be categorized as either temporal, e.g., date, daypart, time, repeat play characteristics, etc., locale, e.g., store site, channel, retailer, network nodes, networks, etc., or demographic, e.g., clusters of audiences grouped based on similar behavior patterns and mapped to geography, network nodes, stores, and the like. Constraints may be specified based on a particular business need, such as “DrinkX is only sold in grocery chain Y” (only show content in this chain of stores) or, based on knowledge gleaned from previous research, such as “DrinkX sells best to students in the afternoon” (target afternoon daypart in network nodes that reach the demographic that most closely represents students). The input variables and constraints provide playlist, optimization, and operational guidance to facility 202.

At step 408, facility 202 uses the received user input to generate a plurality of playlists, or a playlist with a plurality of parameters, designed to enable a learning opportunity to achieve the desired marketing campaign goal. For example, the intersection of the input variables and constraints defines the optimization problem space, as well as the parameters facility 202 systematically varies in order to measure viewer or consumer response and thereby determine better playlists for optimizing the goal. For example, the marketing object may begin its cycle by purposefully sampling across the problem space (vs. a purely random distribution) so that it may develop a more complete data set for analyzing behavioral data over a more complete range of marketing object input variables and constraints. This enables facility 202 to ensure it is testing for, and learning about audience behavior across the range of inputs and can derive playlists that reflect this learning for purposes of measurement and optimization using the aforementioned techniques such as, multivariate regression and stochastic dynamic optimization.

Facility 202 and, in particular, the marketing object evolves and learns as it gathers and maps behavioral and playlog data over time, so that they discover an improving set of playlists to send to the digital signage network for influencing viewer response with respect to the designated goal. Continuing the DrinkX example, facility 202 may learn that, in aggregate, video works better than still images and, in particular, that the video of the model drinking DrinkX works better in western region stores, and that the video of the model pouring DrinkX works better in eastern region stores. Based on its learning, facility 202 and the marketing object adjusts the playlists it sends to the digital signage network to achieve the best results.

At step 410, facility 202 provisions the generated playlists to the points of presence. For example, facility 202 can distribute the playlists to the relevant display servers or media boxes through the digital signage network using integration framework 214. Alternatively, the display servers or media boxes may retrieve updated playlists via an XML web service, or the like, as implemented in integration framework 214. Individual displays or their servers, or media boxes, on the digital signage network may store the playlists so that an application controlling the display can execute the programming as directed by the playlists. Subsequent to provisioning the playlists, facility 202 proceeds to an end step.

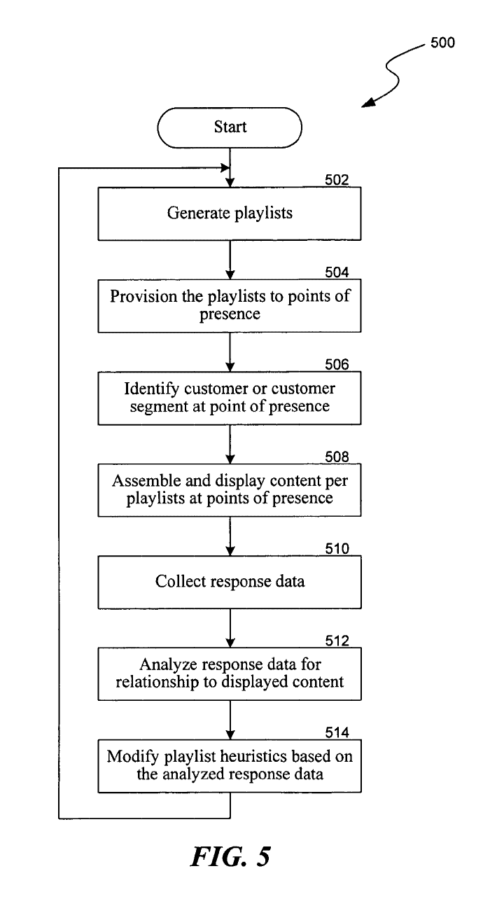

FIG. 5 illustrates a flow chart of a feedback loop process 500, according to one embodiment. During a start step, facility 202 may have received from the user a marketing object (e.g., steps 402-406 of FIG. 4). At step 502, facility 202 uses the user input marketing object to generate playlists designed to enable a learning opportunity to achieve the desired marketing campaign goal in a similar manner as is described in step 408 of FIG. 4. At step 504, facility 202 provisions the playlists to the points of presence in a similar manner as is described in step 410 of FIG. 4.

At step 506, although not necessary, the points of presence devices, or devices proximate to the points of presence, identify and/or classify the characteristics of the viewer or audience. For example, the digital signage network can be integrated with a variety of devices that enable the identification of a specific viewing audience or individuals or as indicators of the audience demographics as a whole. Identification methods may include processes and devices, such as, by way of example, swiping loyalty and credit cards in a card reader, fingerprint identification, image recognition, keyboard input, detection of shopping basket contents using radio frequency identification devices, 3^{rd} party observation, and the like.

At step 508, the point of presence devices (e.g., relevant display servers or media boxes) assemble and present play ready clips per the instructions in the playlists. In one embodiment, although not necessary, a viewer's or audience's identification, or classification, may be established in advance of displaying content per step 506. This allows for mapping of the viewer's profile to a set of rules that may govern which playlist or sets of playlists are invoked. For example, the point of presence devices can assess the conditions (e.g., display is located in southern California and viewer or audience maps to a “family” profile), and check the conditions against a set of rules in order to run a customized version of the programming more appropriate to the identified viewer or audience. In another example, there may be conditional rules that relate to other exogenous factors (vs. audience identification) such as analysis of a shopper's current market basket, reservation, weather, inventory, promotion, etc. The point of presence devices can then systematically run permutations of playlists or the devices may have instructions on preferred content to play, based on prior learning achieved by facility 202, for example, using its measurement and optimization techniques, or derived from other governing business rules specified by the user, such as, “always show an image of ice cream if audience=family”.

At step 510, facility 202 collects the response data. For example, program server computer 106 may be coupled to various systems suitable for collecting and storing audience characteristics and response data, such as, point of sale systems, touch screen applications, motion detectors, image recognition systems, and the like. Facility 202 can then extract and store the response data from the coupled systems.

At step 512, facility 202 analyzes the response data for relationship to displayed content and its metadata. For example, data about the displayed content and playlist history at any given node or nodes on the digital signage network, may be retrieved from the digital signage network in the form of play logs, and facility 202 associates that data with the response data of the proximate audience. Facility 202 may aggregate responses to various populations of people, for example, customers in chain Z's stores in the northeast on weekday mornings. It may also track and analyze particular individual responses. Facility 202 can report on the responses and results from its trials, and perform tests on the statistical significance of the marketing object input variables. For example, facility 202 may employ mathematical methods, such as regression analysis, and produce reports on overall response rates, such as sales data vs. time or location proximate to the content played per the marketing object playlist or playlists. Facility 202 may also report on more advanced orders of analysis such as, by way of example, response rates by play ready clip, timing, geography, demographic, any combination of one or more input variables, or other metadata regarding the marketing campaign. Example metadata might include additional information regarding content, such as its author, color scheme, and the like. Facility 202 may also develop a predictive mathematical model for a campaign over the known parameters as specified in a marketing object using methods such as, by way of example, multivariate regression or dynamic stochastic optimization techniques. These techniques allow facility 202 to make projections, or predictions, of future audience behavior when exposed to various playlists. Periodic refreshing of the predictive model using the most current behavioral and playlist data, enables facility 202 to assess the likelihood that it might improve upon the most current set of playlists deployed on the signage network, and where it might improve the playlist or playlists.

At step 514, facility 202 modifies the playlist heuristics based on the analyzed response data and may do this by comparing the most recent predictive model and implied playlist(s) with respect to the prior predictive model and resultant playlist(s). In one embodiment, facility 202 can automatically, dynamically, and iteratively tune the programming rules and constraints and constraint combinations, in real time or near real-time. For example, facility 202 may eliminate the playlist predicted or analyzed to be lesser performing and/or certain other statistically insignificant content part combinations and parameters from the playlist. Facility 202 then returns to step 502 and generates a new playlist, or playlists, as suggested by the mathematical techniques previously discussed.

A technical advantage of utilizing a networked display signage network capable of providing integrated playlist testing and programming tools with a response feedback loop is the ability to link the content and rule inputs with measured viewer response metrics, which are often disparate systems and interfaces. This permits facility 202 to optimize the set of constraints and potential inputs from a potentially very large selected range of values for selected network display devices. Furthermore, it allows the processes to be automated, and therefore much more comprehensive and efficient than could be managed manually by users.

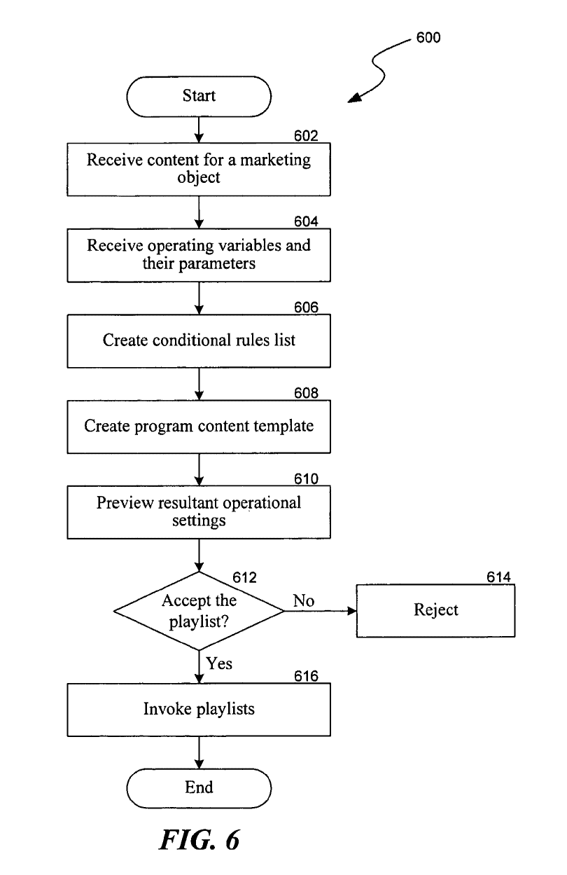

FIG. 6 illustrates a flow chart of a method 600 for previewing playlists, according to one embodiment. In particular, facility 202 enables a user to create a marketing object designed to execute a marketing campaign on a digital signage network in accordance with the user's campaign goals and creative direction, and to preview the resultant playlists and/or network operation characteristics the playlists imply, given the specified marketing object parameters. By way of example, facility 202 may provide a user a user interface that enables the user to manage content (including upload, upload a pointer to content, store, track, preview, etc.) and to set up input variables and constraints which drive playlists and their creation, including the rules and conditions that govern which audience sees the content, what combination of content elements is shown, where, when, under what conditions, and in what format the content element is shown on the digital signage network.

At step 602, facility 202 enables a user to create a marketing object specified to execute a marketing campaign on the digital signage network in accordance with the user's campaign goals and creative direction. In one embodiment, facility 202 saves disaggregated content elements input by the user in user-defined content groups (e.g., images, image layers, copy (including offers, pricing, slogans), layout, audio, etc.) as separate individual “content parts.” Facility 202 is then able to systematically combine the content parts into a set of “play ready clips” which may be presented through the digital signage network in order to determine which combination of content parts produces the best audience response with respect to a goal. Alternatively, the user may designate one or more play ready clips to be included in the proposed campaign and facility 202 is then able to systematically test the content in conjunction with other constraints, if any, to determine, for example, which play ready clip produces the best audience response with respect to a specified goal.

At step 604, facility 202 receives as input from the user the parameters for the input variables, and constraints that define the marketing object. Facility 202 may provide a user interface that enables the user to define these parameters. Parameters can be set for each variable or constraint or groups of variables or constraints. For example, using the interface, the user inputs at least one independent variable, such as a play ready clip, whose value systematically changes, and at least one dependent variable, such as DrinkX brand revenue, which is a response variable that facility 202 tracks in relation to the independent, or input variables.

In one embodiment, independent input variables are user-defined and may include elements such as, by way of example: what content to play (such as play ready media clips, or the metadata that describes a set of media clips to be played), temporal (such as date, daypart, time, and repeat play characteristics), locale (such as store site, channel, retailer, network parameters), demographics (such as income and education levels, or observed behavioral profile clusters mapping to particular geographies such as census blocks or groups of census blocks) and conditional rules. The input variables can be thought of as the “X” or independent variables in the aforementioned regression technique. After the variables are defined, their potential values are identified. For example, if the independent variables are content groups, then the range of values would equal the set of content parts assigned to that group, or a set of play ready clips. The user specifies the element values for each independent variable. For example, if the independent variable is a soda image, the range of values may include three different images to test, e.g., a picture of a soda can only, a picture of someone drinking the soda, and a stylized logo. Other examples may be groups of geographical locations (from individual stores to regional, national, or global groupings) or customer segments.

Another type of independent variable is a variable that may take on a range of discrete values, like price. For this type of variable, the user may specify a range of numerical values and/or increments for facility 202 to test. The user may also specify conditional statements, such as, by way of example, “if customer buys a wallet, then show a key chain,” as a variable. In other embodiments, facility 202 may enable the user to specify collaborative filtering conditions, e.g., “customers who bought X, also rated Y and Z highly or tended to also purchase A and B.”

A goal can be thought of as the “Y” or dependent variable in a regression equation with the “X” or independent variables being the factors that influence sales of the product(s) in question. Marketing object goals can also be specified by users via the campaign workbench in facility 202. A goal is the measure of audience behavior that the user wants to measure and/or optimize for. In one embodiment, a goal comprises a scope and a metric. The scope may be thought of as a product or service hierarchy of category, brand, line, or stock keeping unit (SKU), and the like. The scope may be particular to a given product or service. The metric is what the user wants to measure, such as, by way of example, revenue, volume, units, and the like. Examples of a goal include: revenue for a brand, unit volume for product A, or number of people that enter a store in a week, or viewer touch screen activity. The goal is the target variable the system will derive the optimization function for, and measure its results against. The dependent variables are the measures of behavior that a user is trying to influence.

In other embodiments, facility 202 may enable the user to specify predefined levels for determining statistical significance of the model correlation coefficients, confidence and/or prediction interval thresholds, and other statistical parameters appropriate for the statistical model. These values may affect the number of trials and number of network nodes and signage and audience data grouped necessary to determine the significance of dependent variables. Alternatively, facility 202 may automatically generate a set of default threshold values.

At step 606, facility 202 enables the user to create a conditional rules list. For example, the user may optionally choose to layer a set of conditional rules on top of, or in addition to, the previously specified variable parameters. The conditional rules may help dictate how facility 202 and/or the digital signage network operate. In one embodiment, facility 202 provides a user interface for the creation of logical relationships between variables and conditions. The user may also prioritize the rules in logical order, which causes facility 202 and/or the digital signage network to process the display rules in order of precedence.

At step 608, facility 202 enables the user to create a program content template for the content. For example, the templates may designate where content parts are placed when the content parts are assembled for viewing. In one embodiment, facility 202 provides models for different types of screens on the digital signage network, which can be used by the user to set up rules to handle content transformation in order that the content appears presentable and proper in various formats, e.g., 15″ LCD vs. 40″ plasma, or landscape vs. portrait layout.

At step 610, facility 202 may enable the user to preview the resultant operational settings and summary data, which may include one or more of the following examples: an overview of the programming rules in the playlists and optimization constraints, summary descriptive data on what the operational settings imply with respect to the campaign characteristics such as network coverage, store coverage, demographic coverage, daypart coverage, and the like. For example, the campaign characteristics may be developed by mapping the playlist parameters to other known environment data such as census block information. Facility 202 may also provide the user the ability to preview the play ready clips as the clips appear in the playlist(s). Facility 202 may additionally provide the ability to preview the content parts as they are assembled in the play ready clips. Facility 202 may also provide the ability to preview the logical “trees” of playlists, which may serve to illustrate content flow according to the programmed conditions as specified by the marketing object. Facility 202 may provide the user the ability to modify the rules, operating parameters, constraints, and/or content as necessary.

At step 612, the user decides to either accept or reject the playlist(s) and marketing object parameters. If the user rejects (i.e., not accept) the playlist(s) and marketing object parameters, facility 202 proceeds to reject the playlist(s) and marketing object parameters at step 614. If the user accepts the playlist(s) and marketing object parameters, facility 202 invokes the playlists at step 616. In one embodiment facility 202 invokes the playlists by provisioning the digital signage networks with the playlists for storage in one or more databases on one or more digital signage management or point of presence servers as described using integration framework 214. In one embodiment, playlist provisioning may be implemented as a callable web service via an XML schema, for example, or alternatively can be accomplished by calling the necessary application programming interfaces associated with the relevant digital signage networks. The coupled display devices may then draw upon the databases for the programming rules and the content parts to display. Subsequent to provisioning the points of presence, facility 202 proceeds to an end step. The result is a set of programming rules with respect to the marketing campaign for each display on the digital signage network.

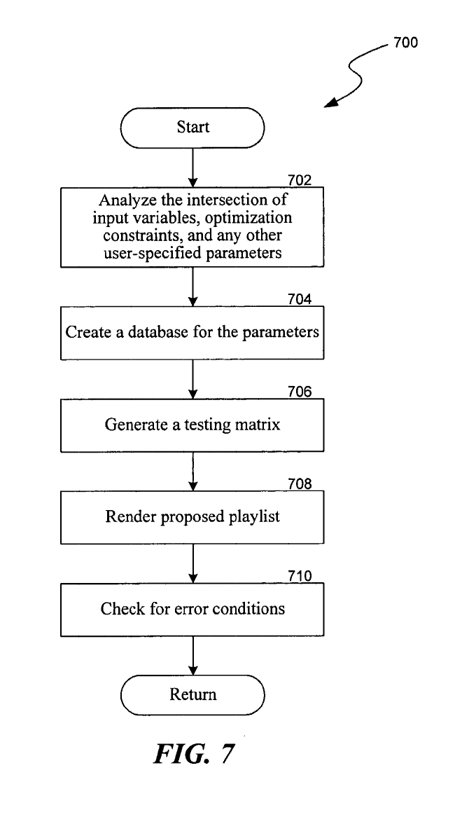

FIG. 7 illustrates a flow chart of a method 700 for creating programming heuristics comprising of one or more playlists, including schedule and rules for each node on the network, according to one embodiment. It will be appreciated by those skilled in the art that the following steps are exemplary in nature, and that actual implementations may include variants of these steps to best match the operating conditions. Beginning at a start step, facility 202 identifies and maps the relevant intersection of user-specified constraints and/or operating parameters on various dimensions including, by example, network specifications such as nodes or groups of nodes; content specifications such as clips or content parts; timing specifications such as day, daypart and repeat characteristics; locale specifications such as geographic region or groups of stores; demographic specifications that map to clusters of audiences in locales (and possibly times) with similar behavior patterns. These parameters serve to form the parameter boundaries from which facility 202 can generate the playlists.

At step 702, facility 202 analyzes the intersection of input variables, optimization constraints, and any other user-specified parameters that would affect whether any content is shown on the points of presence network nodes, or signs. These parameters include, but are not limited to, for example, stores or groups of stores to be included or excluded in the campaign, geographic regions to be included or excluded in the campaign, demographic profiles to be included or excluded in the campaign, and network nodes or groups of nodes (such as a channel) to be included or excluded in the campaign, etc. Facility 202 maps the intersection of these parameters to the specific network nodes using dictionaries (or look up tables) that relate the parameters to the network topology. Example dictionaries include: a mapping of store sites and in-store sign locations to network nodes, a mapping of demographic clusters to store sites, a mapping of geographic regions to network nodes, a mapping of network channels to network nodes, etc.

At step 704, facility 202 creates a database that stores and relates the parameters to each other and to the network nodes. Additional specifications might include content, temporal, and conditional parameters for the campaign such as, by example: content should only run between 4:00 pm and 7:00 pm local time, or content should repeat itself ten times per hour all day long; rotate content A, content B, and content C, display content B or C only when consumer has purchased item X otherwise display content A, etc. In one embodiment, facility 202 may create a list of all possible operations from the database created in step 704. Depending on the implementation, it may be desirable in certain circumstances to specify that the system impose some additional default constraints in order to logically limit the potential list of operations, for example, do not repeat a play ready clip more than X times per hour.

At step 706, facility 202 generates a testing matrix that covers the playlist possibilities for each point of presence, or network node, or groups thereof, based on the implemented statistical process and in a manner which samples across the possible playlists in order to enable an efficient learning opportunity. The testing matrix enables determination of the statistical significance of each input variable using various methods of statistical analysis, such as regression.

For example, the statistical process may be based on multivariate regression, and facility 202 may create a set of possible playlists based on the permutations of the combinations of input variables specified as described above. Facility 202 may select a sample set of playlists in such a way as to begin to statistically represent the defined solution space. Suitable methods for this selection process may vary depending on the stochastic nature of the environment and any prior learning which may be applied in selecting initial playlists to test. Facility 202 generates an initial number of trials that sufficiently and purposefully vary the input variables in order for the facility to map out behavioral response data vs. input variables in a subsequent process. The initial number of trials and/or run time will be set as may be estimated to meet the defined statistical significance criteria. The number of trials for each variable may be re-evaluated during subsequent iterations as facility 202 obtains data with which to base the need for further trials or to drop a particular content program based on the defined set of confidence intervals with respect to statistical significance.

At step 708, facility 202 renders a proposed playlist or playlists for each point or groups of points of presence (or digital signage network nodes) by applying the logic of the user defined input variables, constraints, and the proposed text matrix. At step 710, facility 202 performs a check for possible errors which may include checks, for example, on available advertising inventory at the nodes on the network, or to identify and eliminate and/or correct any impractical schedules, such as for example, too many variables specified which might result in an impractical number of trials to determine the statistical for each variable; statistical significance thresholds set too high, which would result in an unusually large number of trials; conflicting rules, or rules with improper syntax or logic; rules that pertain to undefined parameters; and the like. Subsequent to creating the programming schedule and rules, facility 202 proceeds to return, for example, to a calling process.

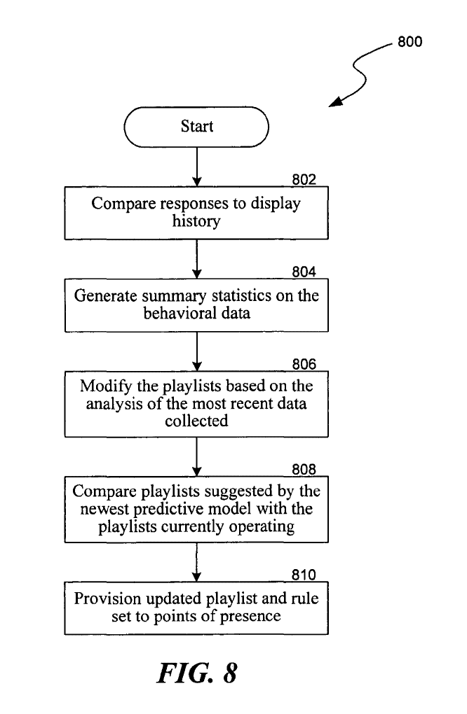

FIG. 8 illustrates a flow chart of a method 800 for performing statistical data analysis to measure behavioral response and to dynamically optimize playlists, according to one embodiment. Beginning at a start step, facility 202 retrieves data from the digital signage network and the point of presence devices. For example, a content server on the digital signage network may monitor, log and store a history of the actual content displayed (which may include other information such as date, time, and locale), and facility 202 may retrieve this information from the content server or other servers on the network which store this information. Facility 202 may retrieve audience behavioral response data from point of presence devices such as, by way of example, touch screen or keyboard/keypad input devices, point of sale systems, inventory tracking systems, store traffic monitors, rfid devices, and the like.

At step 802, facility 202 compares viewer response data to content history data. In one embodiment, facility 202 checks the viewer response data and content history data for integrity (e.g., data consistency, completeness, etc.), and then maps the data to each other. For example, facility 202 relates the playlist data, such as the times and places that play ready clip A was displayed, to the sales results of product X that was featured in play ready clip A.

At step 804, facility 202 generates summary statistics on the behavioral data as well as multiple orders of statistical analysis on the correlation of the input variables to the behavioral data, such as, by way of example, the ratio of sales from clip A to clip B, in California, on the Acme network. In one embodiment, facility 202 creates one or more mathematical predictive models using methods, such as, by way of example, multivariate regression, and the variables are screened for fit and statistical significance versus the observed behavioral data. Facility 202 may utilize the user specified significance thresholds in creating the model(s).

At step 806, facility 202 modifies the playlists based on an analysis of the most recent data collected. In one embodiment, the analysis is performed using one or more mathematical optimization methods and processes, such as, by way of example, variants of dynamic stochastic optimization algorithms, and/or forms of iterative multivariate regression modeling, etc.

At step 808, facility 202 compares the playlist(s) suggested by the new predictive model with the playlist(s) currently operating. For example, the parameters that are statistically demonstrated to contribute most towards achieving the specified goal are given precedence and emphasis in the subsequent playlist iteration, and facility 202 modifies the existing playlist characteristics to reflect the current best predictive model of inputs that influence viewer behavior towards the goal.

At step 810, facility 202 starts the feedback loop cycle by re-provisioning the points of presence with the updated proposed playlist, then proceeds to an end step. In one embodiment, facility 202 operates and collects new response data and display log data, and may iterate process 800, ad infinitum, or until a user changes a set up parameter. In this manner, facility 202 produces a self-tuning public space programming system, which automatically optimizes its content programming based on statistical analysis and prediction of viewer response data.

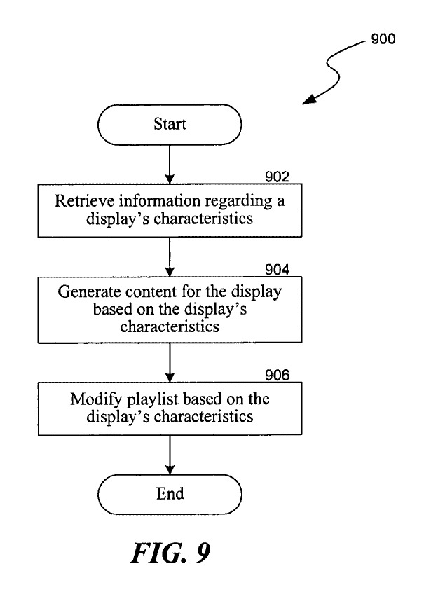

FIG. 9 illustrates a flow chart of a method 900 for incorporating data from a smart media box in creating playlists, according to one embodiment. A smart media box is a computing device that provides local computing and network services for point of presence display devices. A smart media box is composed of hardware, typically with software, which enables its coupled display device to join and become an interactive node in a digital signage network. A smart media box generally broadcasts its displays' characteristics and capabilities (e.g., network identification, type of display (e.g., LCD, CRT, LED, plasma, etc.), resolution, location, current health status, customer identification, input modes, etc.), cache content and programming heuristics for its displays, and log and/or store run time and response data. A smart media box may also provide an interactive facility and/or a facility for gathering for a viewer or audience data as previously described.

Beginning at a start step, facility 202 retrieves information regarding a display's characteristics, at step 902. For example, facility 202 may have received the display's characteristics from a smart media box coupled to the display either directly or via intermediate servers. Facility 202 can profile a network's overall characteristics based on the mediabox deployment across the network. At step 904, facility 202 may generate content for the display based on the display's characteristic information. For example, facility 202 may develop content that is to be played on the display based on the characteristics of the display, such as the display's aspect ratio, size, resolution, potential methods of gathering audience data, etc.

At step 906, facility 202 may modify the playlist based on the display's characteristic information or based on the audience profile as gathered by the media box. In one example, if the information indicates that the display is not operating or functioning properly, facility 202 may remove the display from the playlist. In another example, if the information indicates that the display has newly or recently joined the digital signage network, facility 202 may include the display in the playlist. In another example, facility 202 may learn via the media box that a given display is capable of enabling wireless access and interactivity via remote devices, thus facility 202 provisions the display with a user interface and content that can be browsed interactively vs. other passive forms of content. The smart media box automates notification of these capabilities and enables facility 202 to generate playlists that leverage or appropriately map to network node capabilities. Armed with this information, facility 202 provisions the playlists to the smart media box, and proceeds to an end step.

The following description provides representative scenarios in which the facility may be utilized:

1. Setup: Tim is VP of Marketing at Lilli's, a popular casual dining restaurant chain with sit down table service and counter seating. He is excited because his CEO has just approved the deployment of the new Table Top Merchandising system. With this system, he'll be able to direct targeted content and promotions directly to diners in each of their 1500 locations using high resolution LCD screens placed on individual tables and to counter service patrons via digital menu boards using large projection or plasma screens. On average, there are 20 wired tables at each location, each serving an average of 50 people per day. That works out to 1.5M customers his department can message with as they make their buying decisions each day. While the deployment costs are significant, Tim knows the cost savings from elimination of printed promotional material, combined with the upside in revenue from increased marketing agility, up-sell conversion, and vendor sponsorship will result in an excellent ROI for Lilli's.

2. Full service programming: Now that the Table Top merchandising system is installed in Lilli's restaurants, Lilli's has been able to remove the many promotional menus that used to clutter the table. There is a default program that runs on the screens at each table, but most of the time the host classifies diners at the time they are seated. With the push of a button on the seating kiosk, the screens begin showing content most appropriate for the audience at the table, for example: family with children; one person dining; business diners; young adults; seniors. The program that is shown is intended to be a helpful resource as well as providing some light entertainment or education. The content is phased in order to match the average timing for stages of the meal. The beginning of the program will present appetizers and specialty drinks, then main course offerings. During the meal, the program transitions to happy images—people enjoying their meal, some background information on Lilli's food sources (farmers, fishermen). Later, the program begins to show images of signature desserts as a great way to top off the meal. The program concludes by showing information about Lilli's community involvement and some Lilli's restaurant trivia. It is important to note that the programming has been carefully designed so it is more subtle and suggestive, rather than flashing and annoying to diners at the table. The images transition smoothly and appear to be a well choreographed slide show or film vs. a loud/clashing/flashing bill board with ads. Customers are learning more about Lilli's new menu items—an enticing picture is shown along with nutritional information (particularly for their low fat items) and has seen an uptake in more of their up-scale dishes. Cross sells have also gone up with data-driven suggestive selling: “people who order chicken breast sandwich also tend to purchase a house salad”. Some diners, particularly families with kids, like the entertainment value of the displays—some comic relief with characters and simple games keep the children happy while they wait for food and while the parents finish their meals. Single diners like the trivia questions, news flashes, and weather forecasts they can read. Best of all, Lilli's customer satisfaction, loyalty, and average check size have all increased.

3. Content testing: Bruce is a Lilli's product manager and has been assigned to coordinate the promotions and manage the content that will go over Lilli's Table Top Merchandising system. Lilli's wants to promote Minute Maid orange juice at breakfast time because this is known to be a highly profitable add-on sale for the firm. Bruce has decided to use the system to test a combination of imagery, copy, and prices:
a. no promotion: default Lilli's imagery
b. two product images: one is a close-up still photo of a cold glass of juice, the other is a moving picture of juice getting poured into the glass
c. two tag lines: “Start Out Smart!” and “Get a Fresh Start!”
d. two price points: $1.99 and $2.49

4. Feedback Loop Optimization: Bruce loads these images using the content management tool and identifies them as components that need to be assembled and tested, a total of eight unique combinations. He decides on crop points to accommodate the different aspect ratios of the table top and counter displays. The system automatically sets up a controlled content test schedule in order to determine the most effective merchandising combination in Lilli's locations. Bruce has also turned on a setting that allows the system in each restaurant to tune itself based on what it learns about how effective each combination is. Over time, the displays will feature the content that generates the most response—in this case Bruce has defined success as dollar-volume. Bruce is anxious to learn about variations across different Lilli's locations and to see the uplift achieved in sales.

5. Scheduling: Before the table top programming begins, Bruce uses the content tool to schedule the Minute Maid program. He decides to start by only running the test in Lilli's corporate-owned restaurants in 13 western states, and he sets the system to run the images from 4:00 a.m. until 10:30 a.m. each day.

6. Co-op advertising. loyalty programming: One day, the Lilli's breakfast product manager tells Bruce that he wants to run two new promotions on Kellogg's Fruit Loops for children and a personal “Millstone Coffee Pot” for each table of business diners. The promotions are scheduled in the system, and when diners are seated the host designates the appropriate program to run at each table. Families with children will view the Fruit Loops promotion and adults will see the Millstone Coffee Pot promotion. The diners that participate Lilli's loyalty program swipe their cards in the table top display and they are shown special discounts on the current promotions and are offered programming most relevant to their purchase patterns. These promotions have not only increased restaurant sales, but have also generated co-op revenue from vendors like Kellogg and Millstone, who enjoy elevated brand presence in Lilli's restaurants.

7. Menu Board: Lilli's decides they want to expand into the “fast casual” market by opening up a new gourmet burger chain called McDoodles. Management decides they want a way to make their menu boards digital so they can customize promotions by region, as well as optimize the content by daypart and store customer population. By purchasing this digital signage platform for menu boards, they can do many of the same things as they did on the tables at Lilli's, except that the customers are only segmented in the aggregate store level. Content and offers are optimized to generate the most revenue on a per-store basis throughout the day.

8. Kiosk & counter register display: displays located at the order taking counter or at stand-alone kiosks. Customers exposed to content as they place their orders. Best if have a-priori knowledge of who customer is (via credit card or loyalty card). Similar functionality to scenarios above, system can be used to do order confirmation, display 3rd party advertising content, upsize current orders, and promote new products.

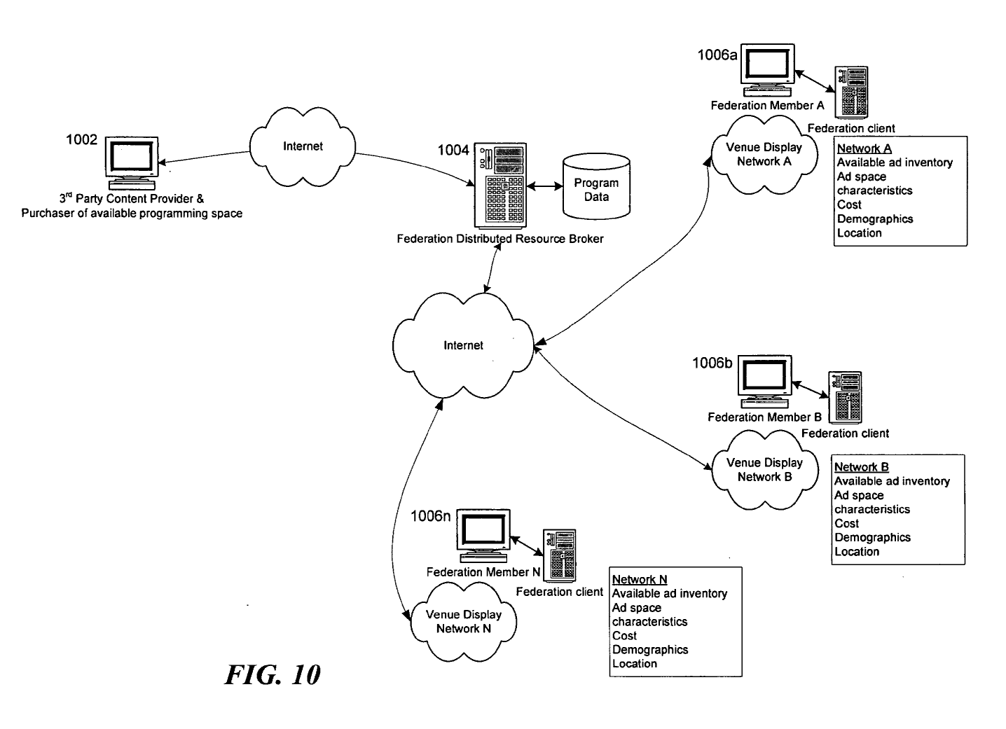

FIG. 10 is a block diagram illustrating a federated network, according to one embodiment. In particular, a federation of a plurality of digital signage networks is provided on one or more central computers. The federation enables a centralized view of digital signage network characteristics, content programming, monitoring, cost settlement, and management of the collective networked devices, screen real estate, response data, and other network resources, on behalf of the individual participating network federation members. For example, a firm may market and sell signage network resources (in aggregate) to third parties, or other federation members, who want to rent the use of particular network resources—such as, displaying particular content to certain individuals, a particular demographic, at a particular venue or class of venues, at particular times. For potential content providers (such as advertisers), it allows them to more easily and efficiently purchase targeted capacity across a plurality of networks from a single, centralized portal.

As depicted in FIG. 10, a computer 1002, which may be a non-federated entity or a federation member, represents a client to the federated network. In one embodiment, computer 1002 is a content provider, meaning it has content (perhaps an advertisement) that it wants to place on one or more public space digital signage networks. Via a web-based interface, it can connect to the federation distributed resource broker, for example, a centralized server computer 1004, to view the available programming inventory, e.g., available advertising time in a schedule, on one or more of the digital signage systems comprising the federated network. This inventory is managed and made known to the rest of the federation using the client software issued to each federation member.

Computer 1002 is able to view, sort, and purchase space on other networks by filtering on signage inventory attributes such as cost, customer profile, locale, screen size, performance, and availability. Computer 1002 also has a set of publishing tools which enable it to post its content to the resource broker (1004), which in turn distributes the playlists (e.g., content and the associated display rules) to the appropriate federation members and their systems. The client tools also provide a framework to handle content transformation so that the content displays appropriately on federation member screens (e.g., a 15″ LCD has different layout requirements than a 40″ plasma screen due to resolution and aspect ratio differences).

In one embodiment, federation members may each operate a digital signage network, for example, venue display systems 1006a-n. Venue display systems 1006a-n receive a notification that there is 3^{rd} party content ready for distribution on their systems waiting for approval. Members access the distributed resource broker via the web to approve the proposed incoming content and to consummate a rental contract. With approval, the content and display rules are pulled into the venue's (federation member's) display network scheduling engine and distributed to the displays or groups of displays. Upon performance, venue display system (120a-n) sends programming history and any response data back to the resource broker. The resource broker (1004) makes programming history and response data available to the contracting 3^{rd} party (computer 1002).

The resource broker (1004) also tracks and manages account balances and billing vs. performance contracts and programming history. The resource broker can handle a “balance of payments” system to cover contracts between federation members—e.g. member A placed content with B, and B placed content with A. The cost of these contracts would all or partially cancel each other out, and one member would pay a sum to the other equaling the net balance due. If the client was not a federation member, it can still see reports on programming performance but would be billed for the full sum of the contract performance. Because the resource broker tracks programming history, content providers have the ability to pay based on actual display performance or frequency vs. paying a fixed sum—without knowing if some screens had actually been dark for some part of the promotional period (either turned off or malfunctioning).

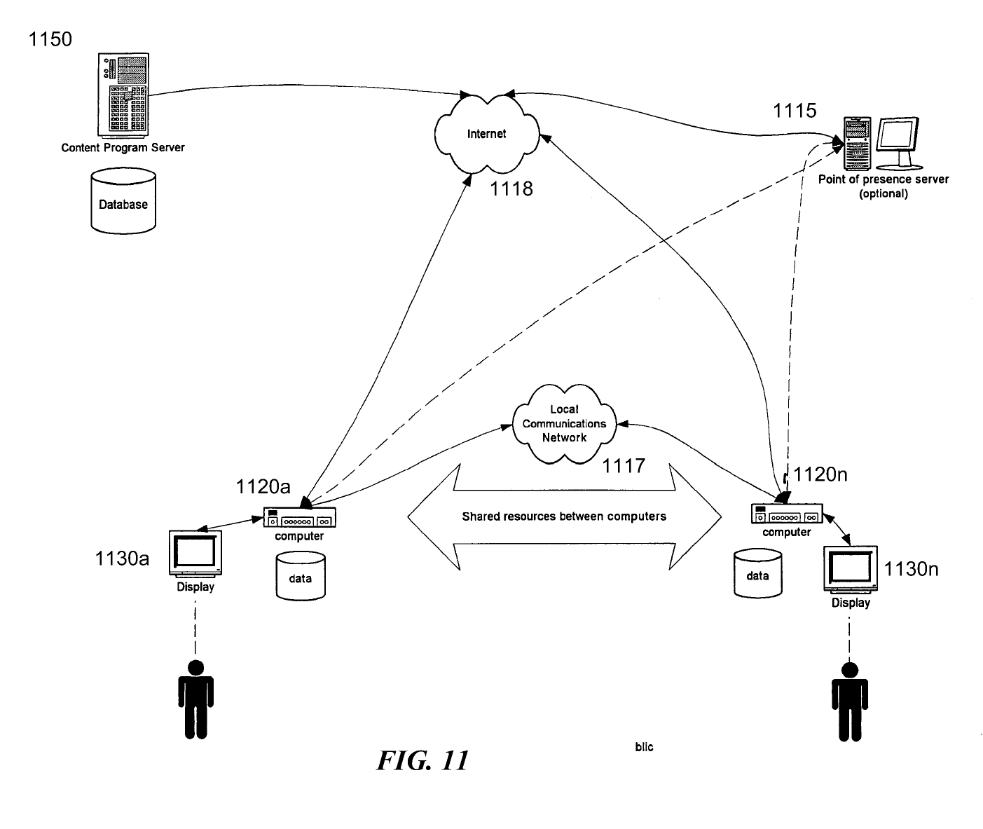

FIG. 11 depicts a peer to peer embodiment of a public space digital signage network. In this configuration, displays 1130a-n each have a corresponding computer 1120a-n. Display device & computer pairs may share the same local area network, or may be connected over a wide area network (such as the internet). They may also share the use of a point of presence server (such as a firewall, or local management server) as a gateway beyond the local area network. This is graphically shown as a dotted line relationship between peers 1120a-n and server 1115. In the peer-to-peer embodiment, computers 1120a-n communicate and share resources with each other via either local or wide area networks (1117 or 1118).

For example, there may be hundreds or thousands of web pages or variations of programming content (or any other piece of data) that could potentially be shown at a given display device. It would take a large amount of memory and bandwidth to distribute and store the totality of content at each computer. In a peer-to-peer embodiment, when a particular piece of content is in demand on computer 1120A, it checks its local store to see if it is available. If not, then it queries its peers on the networks for the content (or data) and retrieves it from the most efficient source. The system can employ a variety of algorithms for this, from a simple first response heuristic to a multivariate “least cost” caching algorithm. Many types of data can be shared in a digital signage network including: programming rule sets, content parts, customer profiles, and customer response and system health data. Shared resources can include ram and disk memory, processor cycles, and network connectivity.

The advantages to this embodiment include:
Computers 1120a-n do not have to be individually resourced as heavily because they will be relying on the shared resources of the collective group of computers. Thus, scaling a network up can be more incremental in cost, vs. a larger step function in cost if it were to be provisioned with an amply resourced computer.
Data Distribution Efficiency: computers only need to download or access data as it is needed, vs. having to store a full data set. Over time, queries take less time because data is automatically be distributed and cached in a pattern based on demand vs. either having to distribute the full data set everywhere, or by dividing the content up with a-priori knowledge of local demand.
Reliability: each computer and/or display device are not dependent upon a common server to function properly. A single computer failure will not cause more than one display to fail. If data integrity is compromised, the computer can rebuild its store or continue to serve content based on the store of its peer machines.

The digital signage system can be further enhanced by enabling users to remotely interact with the display devices. The most useful context for this embodiment is for display devices that are widely visible to the public, such as signs in a sports arena, street, or in a shopping mall vs. 1:1 or 1:few scenarios as might be found in a traditional kiosk. While public space digital signage systems have turned static billboards to dynamic displays, they have not facilitated transactions or provided the audience with an ability to get more information on the featured content.

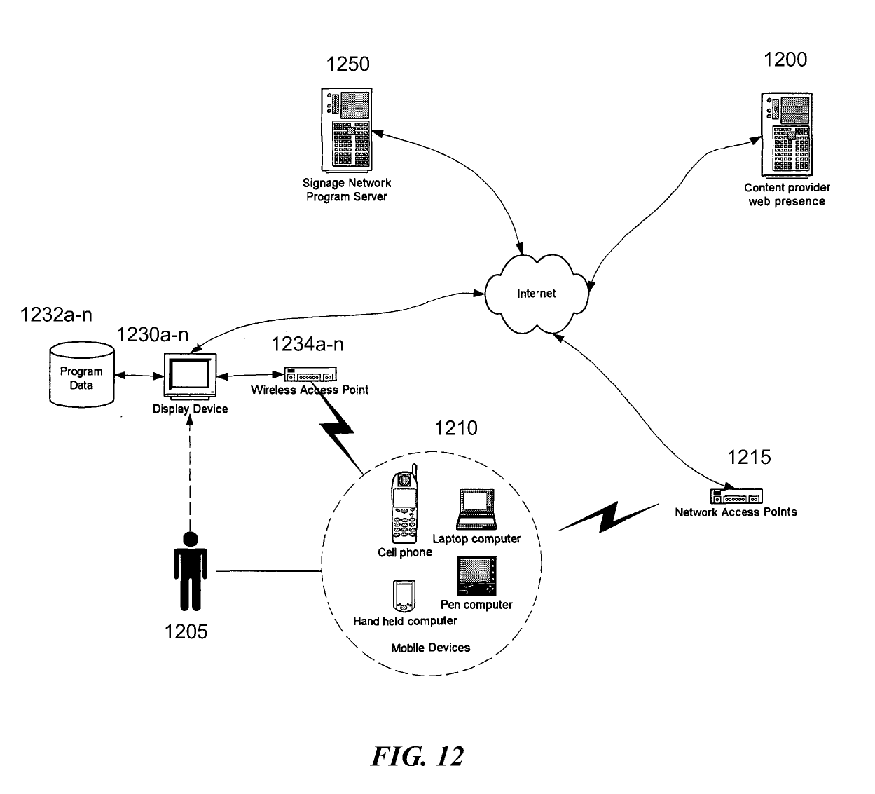

FIG. 12 is a depiction of how the invention can be enhanced to deliver this functionality. Programming rules and content are placed on the network via programming server 1250 and provisioned to display devices 1230a-n (and associated computer and data stores 1232a-n) as previously described in this document. Exemplary display devices in this scenario would include large plasma screen displays, large format LED displays, or rear projection devices—all of which are easily viewed from a distance. It is important to note that the invention is not limited to distance viewing and that the innovation can easily be utilized on devices meant for close-up viewing (such as LCD panels). The heretofore unsolved problem manifests itself when a person or persons (1205) view display content and want more information, but there is no built-in mechanism or easy access to the display device to browse the content.

The invention equips display devices with wireless access points (1234a-n). An embodiment provides access points with transceiver capabilities (both send and receive), though the access points can also be limited to broadcast functionality. The access points preferably enable communication using one or more common standard wireless protocols such as GPRS, 802.11a,b, IR, or “Bluetooth”. The access points broadcast their presence to potential devices (1210) in the area controlled by the audience. The devices have the capability to receive, and may also be able to transmit wirelessly, and include but are not limited to cell phones, PDAs, laptop computers, and tablet computers.

The audience (1205) views the display device and/or discovers the availability of more information via a notification on a mobile device (1210). Notification can leverage existing wireless network configuration paradigms such as the wireless network connection properties and notifications as embodied in Windows XP, or a lightweight connection client can be loaded onto the mobile device (1210) to allow for more customized notification, configuration, and user preference settings.

This connection enables access to content stored directly on the computer. The content could be simply a URL that would provide a pointer to content accessed over the internet (via computer, or a series of HTML web pages that was already cached on computer, perhaps with a link to the content provider's online store (1200).

An optional implementation is for the devices to receive a URL or other pointer (such as a phone number) from the computer and connect to the internet via another available access point. The best implementations would provide the connecting device with a quality of service heuristic to determine the most appropriate connection for the given situation. For example, if the audience was traveling in a car, the useful range of the connection with computer may be limited, and only present enough to broadcast a pointer to more information to all passing devices. If the audience chooses to browse for more information by clicking on the associated user interface notification, then the device can determine the best method of connecting to the internet to retrieve the content. If the audience is traveling in a car, and using a mobile phone, it would likely determine the quality of service is better by connecting using a GPRS mobile data network vs. a Bluetooth or 802.11 network connections.

Example of an Interactive Digital Signage Network: a person in the audience sees a display device that is currently featuring “Victor's” clothing, and he wants to know more about the featured item. The person picks up his PDA and notices there is a pop up cloud that shows “Victors” (and possibly other signage devices) are in range and available for access. The audience clicks on the Victor's icon which does at least one of the following:
Reveals a hyperlink (with an associated URL) to a web site which can be accessed via the best available network connection using alternate access points (1215). (For example, because the user is moving fast it may be that a direct connection using 802.11 is not practical, and that a connection using GPRS is more appropriate.)
Establishes a connection directly with the display device's access point and enables the display of content available for the audience to browse.

The content available for browsing may be cached locally on data store 1232, or may be retrieved on demand via the display device's network connection to Victor's (the content provider's) server (1200). The invention thereby allows an audience to personally interact with a public space display device, get more information, and even convey a commercial transaction. In one embodiment, the content on the display device does not change—the audience browses and views the content via the mobile device that connects to the display device access point. This is desirable since an individual may not want personalized content displayed in front of other people, and if it were to function this way it may effectively render the display device unusable by other people. However, there may be scenarios whereby it would be desirable to have a plurality of mobile client devices interacting with a display device, such as audience polling applications or group interactive games. Thus an alternative implementation would allow for the remote device interaction and the resulting content rendered on the display device.

Since the display device stores programming heuristics, and can garner personal information about the user via the mobile device (using methods such as cookies, user profile mechanisms such as Microsoft's Passport, or the device's machine identity), people in the viewing audience are able to obtain a personalized experience from a public space display device.

When the invention includes interactive signage, it offers the following benefits:
Provides ability to access more detailed product/service information from a distance—the signage providing a visible teaser and “hotspot”
Provides ability to identify who is interacting with the screen, and therefore engage in targeted marketing
Extends the point of purchase away from traditional register counter via remote e-commerce solution
Allows for ad-hoc peer-to-peer interactivity either between sign and customer, or customer-to-customer-to-sign.

To enable these scenarios, the signs have transceivers built into them as hubs to the signage network and the internet.

Capabilities and Benefits

Scenarios

1. Entertainment: Signs in restaurant or lounge/bar are featuring simple games on them such as trivia and checkers. Some of the games are being run off of table top screens. But there is also a trivia game being run off the big screens in the lounge—everyone can participate using their table top display or by using their own pocket pc's or smart phones by downloading a lightweight application that provides interactivity with the signage system. Customers log into the games and then can compete for prizes by responding to onscreen content (answering questions). Players can team up or play individually. Some of the games pit the guys against the girls, left side of the bar vs. right side of the bar, etc. Content on the screen is then interspersed with restaurant promotions, and 3^{rd} party sponsorship (this Bud's for you!)

2. Information: Roy and Roxy are in a restaurant/lounge and they see from the big sign behind the bar that there is a special on tropical drinks tonight. While they look delicious, they aren't that familiar with tropical drinks; Roy uses his PDA to get the complete list of drinks and the ingredients to each one. They both order “Bombay Smashes”.

(Non restaurant): Susan and her children are at the zoo and looking at the gorilla habitat. There is a sign there displaying photos and video of general interest—the latest gorilla birth in the zoo. The sign indicates it is “hot”, meaning more information is available via wireless connection. Susan pulls out her smart phone, connects with the sign, and reads interesting facts about gorillas to her kids. One of children needs to do a report, so she downloads the latest information for later use. Time is short, so Susan chooses to view a map of the zoo to find the quickest route to the bear exhibit. She selects the route and departs, children in tow.

3. Remote commerce: Roy and Roxy pay for their drinks and dinner at their convenience, using Roy's the account information stored on his handheld. The check is cleared, and their server confirms this as they walk out the restaurant.

(non restaurant): Roy and Roxy are walking in the shopping mall where they see a digital sign showing the latest hit movie trailer. The show looks good, so Roy connects to the sign //using his handheld and buys two tickets to the 8:00 show at the theater located in the mall—perfect timing so they can have dinner beforehand. As they continue their walk, they see another digital sign showing off the latest Victor's leather pants. Roxy comments on the how cool the pants look. Roxy's birthday is coming up, so Roy connects to the sign and discreetly orders a pair for Roxy. Victor's has Roxy's sizing already associated with Roy's account, so the transaction is simple. Before completing the transaction, at the suggestion of the signage content, Roy adds a matching haltertop to his order. Roxy will be pleasantly surprised on her birthday!

Meanwhile, the back end of the signage system is programmatically testing its content and measuring the hit rate, click-throughs, and ROI of the ads.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

The invention claimed is:

1. A computer-readable medium whose contents cause a computing system to deploy content to digital signage networks by:
receiving from a user a marketing object, the marketing object comprised of a goal and at least one independent variable suitable for generating a testing plan;
generating two or more playlists and an association between the two or more playlists and one or more displays in a digital signage network, wherein the two or more playlists and the association between the two or more playlists and the one or more displays comprises the testing plan, the testing plan designed to assess the effect of the at least one independent variable on reaching the goal; and
provisioning the two or more playlist˜to the digital signage network.

2. The computer-readable medium of claim 1, wherein the at least one independent variable comprises one or more content parts and a template specification, such that the template specification is used for rendering multiple variations of a plurality of play ready clips generated from the content parts.

3. A method in a computing system for generating playlists of marketing content to present on media devices in physical stores and achieve a marketing campaign goal, the computer-implemented method comprising:
receiving a marketing campaign goal, the marketing campaign goal associated with one or more products and pieces of marketing content related to the one or more products;
receiving an indication of one or more independent variables selected from the group consisting of temporal characteristics, locale characteristics, and demographic characteristics;
generating a testing matrix comprising:
a plurality of playlists, each of the playlists specifying one or more pieces of marketing content related to the one or more products to be presented on a media device, the plurality of playlists differing from one another by one or more variations of value of the indicated independent variables, wherein the testing matrix enables a measurement of an independent variable's effect on reaching the marketing campaign goal; and
an association between a subset of the plurality of playlists and one or more media devices in a digital signage network; and
provisioning the plurality of playlists in accordance with the testing matrix to the digital signage network, each playlist causing the marketing content associated with that playlist to be presented to an audience on one or more media devices;
wherein one or more computer processors execute the steps above to implement the method.

4. The computer-implemented method of claim 3, further comprising:
receiving data characterizing behavior of the audience in locations where the playlists have been executed;
analyzing the received audience behavior data to identify those values of the independent variables that were beneficial to reaching the marketing goal; and
utilizing the identified playlists values of the independent variables that were beneficial to reaching the marketing goal to modify the testing matrix and create one or more improved playlists to achieve the marketing goal when presented to an audience.

5. The computer-implemented method of claim 4, wherein stochastic optimization algorithms are utilized to create the one or more improved playlists.

6. The computer-implemented method of claim 4, wherein the data characterizing audience behavior is selected from the group consisting of sales data, inventory tracking data, foot traffic data, and data characterizing interaction with a device.

7. The computer-implemented method of claim 4, further comprising:
receiving data characterizing the marketing content that was presented on the one or more media devices; and
using the received data characterizing the presented marketing content in conjunction with the analysis of the received audience behavior data to identify those independent variables that were beneficial to reaching the marketing goal.

8. The computer-implemented method of claim 3, wherein the marketing goal comprises revenue, volume, units associated with the one or more products or audience traffic.

9. The computer-implemented method of claim 3, wherein a temporal characteristic is selected from the group consisting of date, daypart, time, and repeat play characteristics.

10. The computer-implemented method of claim 3, wherein a locale characteristic is selected from the group consisting of store site, group of store sites, channel, retailer, network nodes, and network.

11. The computer-implemented method of claim 3, wherein a demographic characteristic is selected from the group consisting of income level, education level, and cluster of audience grouped based on similar behavior pattern and mapped to geography or location.

12. The computer-implemented method of claim 3, further comprising determining an initial number of trials that a playlist should be repeated on a corresponding media device.

13. The computer-implemented method of claim 3, wherein the media devices are displays.

14. The computer-implemented method of claim 3, wherein a conditional rule is specified which alters the playlists when the conditional rule is satisfied.

15. The computer-implemented method of claim 3, wherein the marketing campaign goal comprises a scope of a product or a service, and a metric to measure.

16. The computer-implemented method of claim 15, wherein the scope is selected from the group consisting of a category, a brand, a line, and a stock keeping unit.

17. The computer-implemented method of claim 15, wherein the metric is selected from the group consisting of revenue, volume, and units.

18. The computer-implemented method of claim 3, wherein the marketing campaign goal comprises a scope of an audience member action, and a metric to measure.

19. The computer-implemented method of claim 18, wherein the metric is selected from the group consisting of a location of an audience member, an audience member interaction with a display device, and an audience member interaction with a data gathering system.

20. The computer-implemented method of claim 3, further comprising receiving a conditional rule, the conditional rule causing a modification to the testing matrix when the conditional rule is satisfied.

21. The computer-implemented method of claim 20, wherein the conditional rule is linked to an event that is exogenous to the digital signage network.

22. The computer-implemented method of claim 20, wherein the modification to the testing matrix is selected from the group consisting of: a selection of a display that is to receive content, a selection of content that is to be delivered to a display, and a selection of a playlist for provisioning to a display.

23. The computer-implemented method of claim 21, wherein the event is selected from the group consisting of: a content of a shopping cart, an identification of an individual, an identification of an audience, an inventory level, and a weather condition.

24. The computer-implemented method of claim 3, further comprising:
receiving a constraint applicable to the testing matrix; and
modifying the testing matrix in accordance with the received constraint.

25. The computer-implemented method of claim 24, wherein the received constraint is selected from the group consisting of a temporal constraint, a locale constraint, and a demographic constraint.

26. The computer-implemented method of claim 24, wherein the received constraint is a repetition constraint on content.

27. The computer-implemented method of claim 24, wherein the received constraint pertains to an independent variable.

28. The computer-implemented method of claim 24, wherein the received constraint is based on an analysis of behavioral response data from a prior testing matrix associated with a different marketing campaign goal.

29. The computer-implemented method of claim 24, wherein the received constraint is based on an analysis of behavioral response data from playlists associated with a different marketing campaign goal.

30. The computer-implemented method of claim 3, further comprising generating an interface to allow a user to review an aspect of the testing matrix prior to provisioning the plurality of playlists in accordance with the testing matrix.

31. The computer-implemented method of claim 3, wherein a playlist comprises one or more pointers to content.
